(19) United States
(12) Patent Application Publication
(10) Pub. No.: US 2011/0181061 A1
(43) Pub. Date: Jul. 28, 2011

(54) Bumper Assembly For A Plurality Of Different Vehicles

(75) Inventor: Ronald Hickenbottom, Sullivan, IL (US)

(73) Assignee: AGRI-FAB, INC., Sullivan, IL (US)

(21) Appl. No.: 12/693,074

(22) Filed: Jan. 25, 2010

(51) Int. Cl. B60R 19/02

(52) U.S. Cl. 293/102

(57) ABSTRACT

A bumper assembly is disclosed for selective securement to one of a plurality of different vehicles, each having a different mounting point pattern. A bumper mounting plate includes a first portion for connection to one of the vehicles and a second portion connected to a bumper. The first portion includes a plurality of discrete sets of mounting opening patterns that are not shared in connection with the mounting point patterns.

### FIELD OF THE DISCLOSURE

The present disclosure is related to a bumper assembly for a vehicle and, more particularly, a singular bumper assembly for a plurality of different vehicles.

### BACKGROUND

There are various vehicle manufacturers and each offers many different models of vehicles. This disclosure is directed to what are commonly referred to as lawn and garden tractors by way of example only, and not in any way limiting. Such manufacturers of lawn and garden tractors usually do not install a bumper assembly as original equipment. However, operators of such lawn and garden tractors have recognized that a bumper assembly is useful for such a vehicle, as can be observed from other vehicles, to prevent damage to the front of the vehicle, to provide a secure tie down or pulling point or to provide an additional mount for an accessory such as lights, snow blade or any other useful accessory.

Since such a useful item was not originally provided by the manufacturers, mounting an aftermarket bumper assembly to a vehicle can present issues because there is no standard mounting point pattern for a bumper assembly on a lawn and garden tractor. In order to provide an aftermarket bumper assembly for each lawn and garden tractor on the market, an aftermarket manufacturer would have to design and make numerous bumper assemblies, not limited to each manufacturer, but to include each model of each manufacturer as well. The costs to implement such an ambitious venture is overwhelming. Accordingly, aftermarket manufacturers restrict bumper assembly product lines to only the most successfully sold lawn and garden tractors. As a result, they face increased competition and decreased revenue. Therefore, there exists a need for a bumper assembly that can be secured to a plurality of different vehicles.

### BRIEF DESCRIPTION OF THE DRAWINGS

The following disclosure as a whole may be best understood by reference to the provided detailed description when read in conjunction with the accompanying drawings, drawing description, abstract, background, field of the disclosure, and associated headings. Identical reference numerals when found on different figures identify the same elements or a functionally equivalent element. The elements listed in the abstract are not referenced but nevertheless refer by association to the elements of the detailed description and associated disclosure.

FIG. 1 is a perspective view of a vehicle including a bumper assembly in accordance with an embodiment of this disclosure.

FIG. 2 is a perspective view of the bumper assembly of FIG. 1.

FIG. 3 is a side elevation view of the bumper assembly of FIG. 2.

FIG. 4 is an exploded detail view of the bumper assembly of FIG. 2 configured for connection to one of a plurality of vehicles.

FIG. 5 is an exploded detail view of the bumper assembly of FIG. 2 configured for connection to another one of the plurality of vehicles.

FIG. 6 is an exploded detail view of the bumper assembly of FIG. 2 configured for connection to another one of the plurality of vehicles.

### DETAILED DESCRIPTION

The present invention is not limited to the particular details of the apparatus depicted, and other modifications and applications may be contemplated. Further changes may be made in the device without departing from the true spirit of the scope of the invention herein involved. It is intended, therefore, that the subject matter in this disclosure should be interpreted as illustrative, not in a limiting sense.

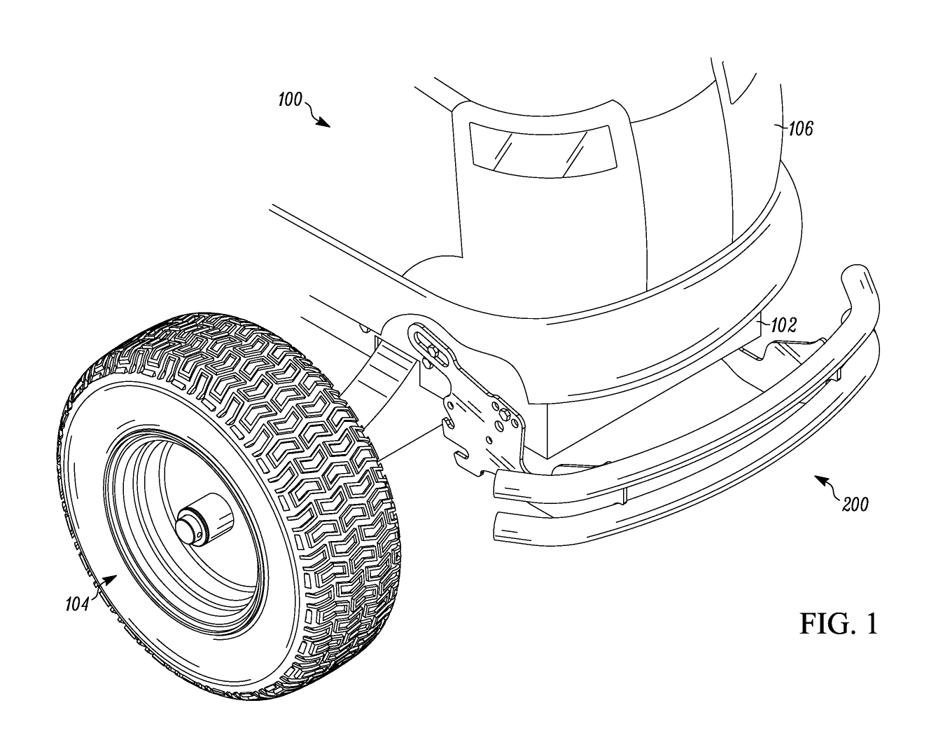

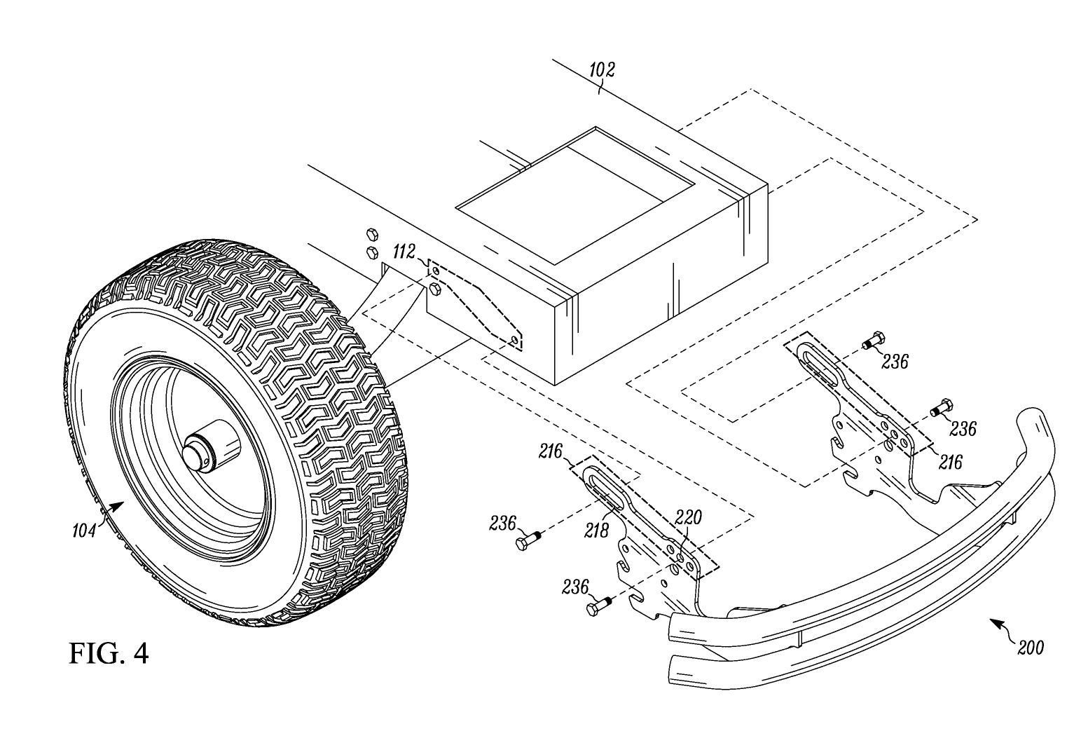

FIG. 1 is a perspective view of a vehicle 100 including a bumper assembly 200 in accordance with an embodiment of this disclosure. The vehicle 100 may be configured for any useful purpose. This disclosure is directed to what are commonly referred to as lawn and garden tractors by way of example only, and not in any way limiting. One of ordinary skill in the art will recognize that similar structural and functional aspects of the present disclosure may be equally applied to other vehicles. In one embodiment, the vehicle 100 is a lawn and garden tractor including a frame 102, a wheel and tire combination 104 movably connected to the frame, a body 106 movably connected to the frame and other structural components one of ordinary skill in the art would expect to find on a similar vehicle. The frame 102 may include a plurality of openings 108 formed therein (see FIGS. 4-6). Preferably, in one embodiment, the openings 108 have a threaded portion disposed on interior surface of the opening 108. One of ordinary skill in the art will recognize that other suitable engagement or retaining structural elements may be formed on the interior surface of the openings 108 to perform an equivalent function. Preferably, in one embodiment, the openings 108 are arranged in a mounting point pattern 112 (see FIGS. 4-6) that is specific to the manufacturer and/or model of lawn and garden tractor. One of ordinary skill in the art will recognize that each manufacturer and/or model of vehicles uses a different mounting point pattern 112. As a result, each lawn and garden tractor has a different mounting point pattern 112. Generally, lawn and garden tractors are not equipped with a bumper assembly as original equipment from the manufacturer.

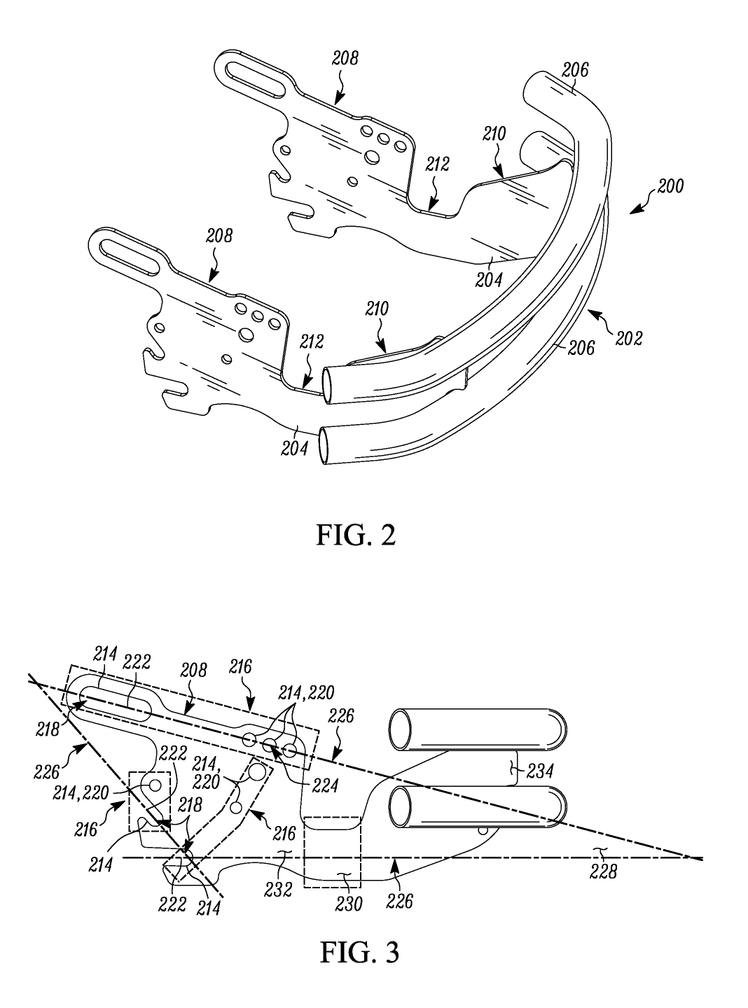

FIG. 2 is a perspective view of the bumper assembly 200 of FIG. 1. The bumper assembly 200 includes, in one embodiment, a bumper 202 and a bumper mounting plate 204. The bumper 202 may have a tubular element 206 or any other suitable configuration to perform the intended function. Preferably, in one embodiment, the bumper 202 includes a pair of tubular elements 206 that have a slight curvature around the front of the vehicle 100 when viewed from the top to provide the intended functions. Other desirable structural and/or functional aspects may be incorporated into the bumper assembly 200 in accordance with this disclosure.

In one embodiment, the bumper mounting plate 204 includes a first portion 208 and a second portion 210 separated by a necked portion 212. The first portion 208 is preferably configured for connection to one of a plurality of different vehicles, each having a different mounting point pattern 112. The second portion 210 is connected to the bumper 202. Preferably, in one embodiment, a pair of bumper mounting plates 204 are connected to the bumper 202 at different positions. One of ordinary skill in the art will recognize that any other suitable structural configuration may be used to facilitate the intended function.

FIG. 3 is a side elevation view of the bumper assembly of FIG. 2. The first portion 208, in one embodiment, includes a plurality of discrete sets of mounting openings 214, where each set defines a separate mounting opening pattern 216. Preferably, the mounting openings 214 are configured to facilitate connection of the bumper assembly 200 to the vehicle 100. In one embodiment, as described in more detail below, a threaded fastener may be inserted through the mounting openings 214 to engage the threaded portion of the openings 108 formed in the frame 102 and thereby secure the bumper assembly 200 to the vehicle 100. It will be recognized by one of ordinary skill in the art that any suitable fastener or device may be used to engage the mounting openings 214 to secure the bumper assembly 200 to the vehicle 100, for example, quarter-turn fasteners, bayonet connectors, studs, pins and any other suitable structure to perform the intended function.

Preferably, in one embodiment, each mounting opening pattern 216 includes an elongated opening 218 and a generally symmetrical opening 220, such that no elongated opening 218 or generally symmetrical opening 220 is shared between the plurality of mounting opening patterns 216. Each elongated opening 218 includes a longitudinal axis 222 that defines a line 226. In one embodiment, a center 224 of the generally symmetrical opening 220 is aligned collinear along the longitudinal axis 222 and the line 226. In another embodiment, the center 224 of the generally symmetrical opening 220 is disposed offset from the longitudinal axis 222 and the line 226. The lines 226 defined by the longitudinal axis 222 of each elongated opening 218 intersect to define a triangle 228. In one embodiment, at least one generally symmetrical opening 220 is disposed within the triangle 228. In another embodiment, at least one generally symmetrical opening 220 is disposed outside the triangle 228.

The first portion 208 is separated from the second portion 210 by a necked portion 212. In one embodiment, the necked portion 212 has a surface area 230 that is substantially less than a first portion surface area 232 or a second portion surface area 234.

FIG. 4 is an exploded detail view of the singular bumper assembly 200 of FIG. 2 configured for connection to one of a plurality of vehicles 100 where each of the vehicles 100 has a different mounting point pattern 112. In this embodiment, the first mounting opening pattern 216 includes one elongate opening 218 and one generally symmetrical opening 220 disposed in alignment with the mounting point pattern of one of the vehicles 100. A threaded fastener 236 is configured to pass through the elongated opening 218 and the generally symmetrical opening 220 and engage the mounting point pattern of this one of the vehicles 100.

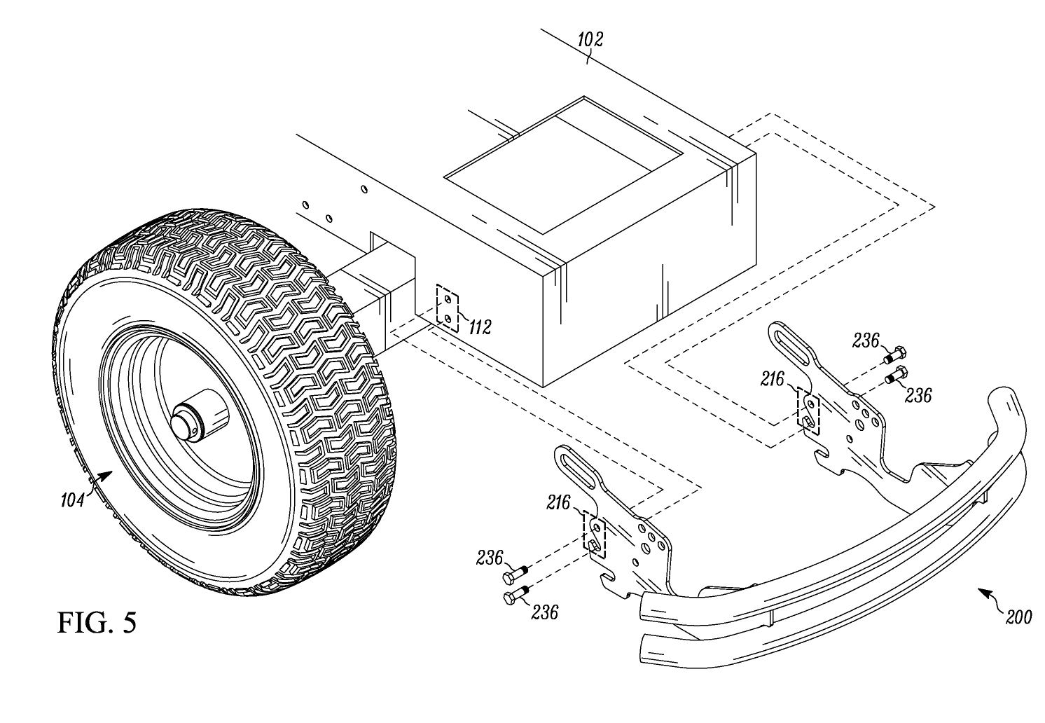

FIG. 5 is an exploded detail view of the singular bumper assembly 200 of FIG. 2 configured for connection to another one of a plurality of vehicles 100 where each of the vehicles 100 has a different mounting point pattern 112. In this embodiment, the first mounting opening pattern 216 includes one elongate opening 218 and two generally symmetrical openings 220 disposed in alignment with the mounting point pattern of another one of the vehicles 100. A threaded fastener 236 is configured to pass through the elongated opening 218 and at least one of the generally symmetrical openings 220 and engage the mounting point pattern of this one of the vehicles 100.

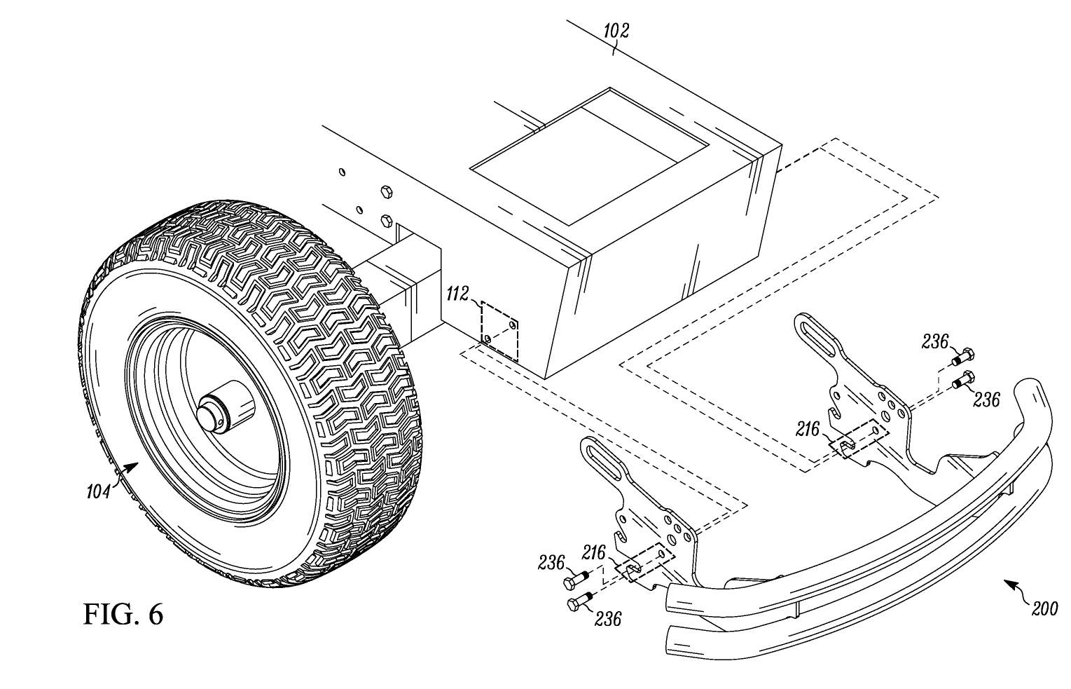

FIG. 6 is an exploded detail view of the singular bumper assembly 200 of FIG. 2 configured for connection to another one of a plurality of vehicles 100 where each of the vehicles 100 has a different mounting point pattern 112. In this embodiment, the first mounting opening pattern 216 includes one elongate opening 218 and two generally symmetrical openings 220 disposed in alignment with the mounting point pattern of another one of the vehicles 100. A threaded fastener 236 is configured to pass through the elongated opening 218 and at least one of the generally symmetrical openings 220 and engage the mounting point pattern of this one of the vehicles 100.

The preceding detailed description is merely some examples and embodiments of the present disclosure and that numerous changes to the disclosed embodiments can be made in accordance with the disclosure herein without departing from its spirit or scope. The preceding description, therefore, is not meant to limit the scope of the disclosure but to provide sufficient disclosure to one of ordinary skill in the art to practice the invention without undue burden.

What is claimed is:

1. A singular bumper assembly for selective securement to one of a plurality of different vehicles, each vehicle having a different mounting point pattern, said assembly comprising: a bumper and a bumper mounting plate including a first portion for connection to one of the vehicles and a second portion connected to the bumper, the first portion including a plurality of discrete sets of mounting openings that each said set defines a separate mounting opening pattern including an elongated opening and a generally symmetrical opening such that no elongated opening or generally symmetrical opening is shared between said mounting opening patterns.

2. The assembly as recited in claim 1, wherein a pair of bumper mounting plates are connected to the bumper at different positions.

3. The assembly as recited in claim 1, wherein the first portion is separated from the second portion by a necked portion having a surface area substantially less than a first portion surface area or a second portion surface area.

4. The assembly as recited in claim 1, wherein one mounting opening pattern further comprises the elongated opening having a longitudinal axis and the generally symmetrical opening aligned collinear along said longitudinal axis to define a line.

5. The assembly as recited in claim 1, wherein each elongated opening has a longitudinal axis that defines a line.

6. The assembly as recited in claim 5, wherein each line intersects the other lines.

7. The assembly as recited in claim 5, wherein the lines define a triangle.

8. The assembly as recited in claim 1, wherein a first mounting opening pattern includes one elongated opening and one generally symmetrical opening and the first mounting opening pattern aligns with the mounting point pattern of one of the vehicles.

9. The assembly as recited in claim 1, wherein a second mounting opening pattern includes one elongated opening and two generally symmetrical openings and the second mounting opening pattern aligns with the mounting point pattern of one of the vehicles.

10. The assembly as recited in claim 1, wherein a third mounting opening pattern includes one elongated opening and three generally symmetrical openings and the third mounting opening pattern aligns with the mounting point pattern of one of the vehicles.

11. An assembly comprising: a vehicle including a mounting point pattern for a bumper assembly, said bumper assembly comprising a bumper and a bumper mounting plate, the bumper mounting plate including a first portion connected to the vehicle and a second portion connected to the bumper, the first portion including a plurality of discrete sets of mounting openings that each said set defines a separate mounting opening pattern including an elongated opening and a generally symmetrical opening, wherein one of the mounting opening patterns aligns in registration with the mounting point pattern to facilitate connection of the bumper assembly to the vehicle.

12. The assembly of claim 1, wherein the first portion is separated from the second portion by a necked portion having a surface area substantially less than a first portion surface area or a second portion surface area.

13. The assembly of claim 1, wherein one mounting opening pattern further comprises the elongated opening having a longitudinal axis and the generally symmetrical opening aligned collinear with said longitudinal axis to define a line.

14. The assembly of claim 1, wherein each elongated opening has a longitudinal axis that defines a line.

15. The assembly of claim 14, wherein each line intersects the other lines.

16. The assembly of claim 14, wherein the lines define a triangle.
